(19) United States
(12) Patent Application Publication
(10) Pub. No.: US 2024/0425285 A1
(43) Pub. Date: Dec. 26, 2024

(54) NATURAL HYDROGENATION OF AN ORGANIC CARRIER AT UPSTREAM CONDITIONS

(71) Applicant: SAUDI ARABIAN OIL COMPANY, Dhahran (SA)

(72) Inventors: Adrian Cesar Cavazos Sepulveda, Nuevo Leon (MX); Mohammed A. Daous, Jeddah (SA)

(73) Assignee: SAUDI ARABIAN OIL COMPANY, Dhahran (SA)

(21) Appl. No.: 18/341,022

(22) Filed: Jun. 26, 2023

(51) Int. Cl. B65G 5/00; C01B 3/00

(52) U.S. Cl. CPC B65G 5/00; C01B 3/0015

(57) ABSTRACT

A hydrogenation system includes an organic carrier injection line for injecting an organic carrier comprising one or more selected from a liquid organic carrier, a non-liquid organic carrier, or combinations thereof to a formation location, and a catalyst injection line configured for injecting a catalyst to the formation location. The hydrogenation system is reacts the organic carrier, the catalyst, and a reactive hydrogen compound at a subsurface location, hydrogenate the organic carrier, and form a hydrogenated organic carrier. The formation location of the hydrogenation system is a subsurface environment, near-subsurface environment, a surface connected environment, or any combination thereof. A method for hydrogenation includes providing an organic carrier to a formation location, providing a catalyst to the formation location, and reacting the organic carrier, the catalyst, and a reactive hydrogen compound at the formation location, thereby forming a hydrogenated organic carrier.

### BACKGROUND

Hydrogen gas has many uses in applications, such as use in the chemical industry, as a fuel for transport, as well as a means for energy storage. In order to be used in these applications, hydrogen gas may be stored through various means. Storage of hydrogen gas underground may be useful for stabilizing power grid output in the operation of intermittent energy sources, such as solar or wind power, as well as providing fuel for electricity generation and transportation.

However, hydrogen is a low-density material; 1 kg of hydrogen gas occupies over 11 m³ at atmospheric pressure and room temperature. This means that a large amount of hydrogen necessarily requires a large volume to store under these conditions. Hydrogen is also a highly volatile and reactive compound that can permeate even through some metals and joints. Additionally, hydrogen can degrade by reacting with a plurality of materials and chemicals. Furthermore, hydrogen and other hydrogen containing reactive species (e.g., hydrogen sulfide, H₂S) are subject to chemical or biotic processes where microbes can metabolize hydrogen and other hydrogen reactive species to degrade them through degradation mechanisms, such as methanogenesis or sulfur reduction processes.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter. In one aspect, embodiments disclosed herein relate to a hydrogenation system. The hydrogenation system includes an organic carrier injection line configured for injecting an organic carrier comprising one or more selected from a liquid organic carrier, a non-liquid organic carrier, or combinations thereof to a formation location, and a catalyst injection line configured for injecting a catalyst to the formation location. The hydrogenation system is configured to react the organic carrier, the catalyst, and a reactive hydrogen compound at a subsurface location, hydrogenate the organic carrier, and form a hydrogenated organic carrier. The formation location of the hydrogenation system is a subsurface environment, near-subsurface environment, a surface connected environment, or any combination thereof.

In another aspect, embodiments herein relate to a method for hydrogenation. The method includes providing an organic carrier to a formation location via an organic carrier injection line, providing a catalyst via a catalyst injection line to the formation location, and reacting the organic carrier, the catalyst, and a reactive hydrogen compound at the formation location, thereby forming a hydrogenated organic carrier.

Other aspects and advantages of the claimed subject matter will be apparent from the following description and the appended claims.

### BRIEF DESCRIPTION OF DRAWINGS

FIG. 1 is a diagram of a non-limiting example of a hydrogenation system in accordance with one or more embodiments.

FIG. 2 is a block flow diagram of a method 200 for hydrogenating an organic carrier in accordance with one or more embodiments.

### DETAILED DESCRIPTION

In view of the high reactivity of hydrogen and hydrogen sulfide, the subsurface extraction and transportation of such compounds presents major challenges. Embodiments disclosed herein relate to reversibly storing a hydrogen containing compound (e.g., hydrogen, hydrogen sulfide, or combinations thereof) on an organic carrier. The reaction of a hydrogen containing compound and an organic carrier can require a large amount of energy and complex systems to force the reaction to form a hydrogenated organic carrier.

For example, gaseous hydrogen has a Gibbs free energy of 0 KJ/mol (kilojoules per mole) and hydrogen sulfide (H₂S) has a Gibbs free energy of −33 KJ/mol. Organic carriers can have a Gibbs free energy in a range from −35 KJ/mol to −150 KJ/mol, indicating their relative thermodynamic stability against hydrogenation reactions. Thus, although the chemical potential to drive hydrogenation to form hydrogenated organic carriers is readily available, such as in structural reactivity of organic carriers, kinetic energy barriers hinder reactivity of organic carriers toward hydrogenation. In order to circumvent these obstacles, higher pressures and temperatures are required to activate a catalyst of the hydrogenation reaction and, in extreme cases, to drive the reaction by means of sufficient equilibrium shifting in accordance with LeChatelier's principle.

Traditional methods for hydrogenation of organic carriers require high performance pumps to pressurize as well as heat reaction units in order to achieve the hydrogenation. For example, conventional hydrogenation reactions are held at a pressure of about 200 psi to 750 psi and ranging from temperatures of approximately 40° C. to 300° C. In these reactions, a surplus of pressure further shifts the equilibrium of the reaction to proceed in a product forming direction at lower temperatures such that hydrogenation may occur under conditions with a temperature in a range from 25° C. to 300° C. and pressure in a range from 40 psi to 3500 psi.

As such, embodiments disclosed herein relate to a system and method for the subsurface hydrogenation of organic carriers (e.g., organic carriers) at upstream conditions, such as at conventional temperatures and pressures to form hydrogenated organic carriers. Sequestration of hydrogen in organic carriers of one or more embodiments and transportation of the sequestered hydrogen may be performed in a systematic manner in line with subsurface infrastructure. Subsurface infrastructure may include a wellbore, a near-wellbore location, a wellhead, surface piping, or any combination thereof. The subsurface infrastructure may be an existing subsurface infrastructure. The subsurface infrastructure may include one or more existing units located at a formation location, such as in an existing well.

In one or more embodiments, subsurface formation temperatures and pressures are used to promote the hydrogenation of organic carriers. In some embodiments, the hydrogenation of an organic carrier is facilitated by providing energy harvested from an energy source. The energy source may include a hydrocarbon-bearing reservoir, a geothermal reservoir, nuclear power plant, renewable energy sources (e.g., wind, solar, water sources), or any combination thereof. Harvested thermal energy may include, but is not limited to, energy derived from geothermal energy, renewable energy (e.g., solar energy), nuclear energy, energy harvested from hydrocarbon combustion, or combinations thereof. In some embodiments, harvested energy could be supplied from the energy source in the form of a heat exchanger. In such embodiments, the heat exchanger can trap, convert, and store thermal energy. In some embodiments, the thermal energy is harvested from the hydrogenation reaction itself. For surface conditions, thermal energy may be harvested directly from solar energy.

For the purposes of this application, a “formation” is a contiguous subsurface geological structure. A “reservoir” is a type of formation that that may retain a fluid within its contiguous structure, such as freshwater, brine, crude oil, condensates, natural gas, a reactive hydrogen compound (e.g., hydrogen, hydrogen sulfide), or combinations thereof. A hydrocarbon-bearing reservoir may currently be under hydrocarbon production or may have previously been under hydrocarbon production. A reservoir is a formation, but a formation may not be a reservoir.

The term “wellbore” refers to a hole drilled in the ground in order to look for or extract natural resources such as oil and gas. Wellbores are usually drilled in order to penetrate a reservoir that contains hydrocarbons, and such hydrocarbons are recovered to bring on a surface from the underground reservoir by extraction through a wellbore. A wellbore is also known as a borehole and may be cased with cement and steel to increase formation stability. The surface end of a wellbore may be referred to as the “uphole” end; the end of the wellbore distal from the uphole end is the “downhole” end of the wellbore. This terminology is consistent despite the overall orientation of the wellbore at a given point: vertical, approximately vertical, deviated, approximately horizontal, and horizontal.

### Hydrogenation System

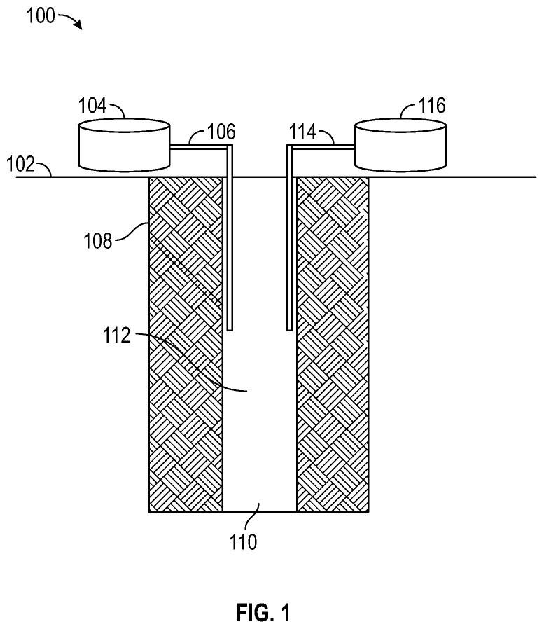

In one aspect, embodiments herein relate to a hydrogenation system (or “system”) that is configured to promote a hydrogenation reaction in an environment that includes subsurface infrastructure. The system may include one or more components selected from the group consisting of an organic carrier, a catalyst, a reactive hydrogen compound, one or more injection lines disposed in a wellbore of a formation, and combinations thereof. The system may be configured to transport an organic carrier, a catalyst, a reactive hydrogen compound, or combinations thereof from a surface location to a downhole location in a wellbore disposed in a formation. The system may include one or more units configured to pump chemicals downhole as known to those of ordinary skill in the art. For example, the system may include a pumping unit, a fluid flow system (e.g., a venturi), a differential pressure injector (e.g., a Mazzei injector), capillary tubing. Tesla valve, among other components. FIG. 1 is a diagram of a non-limiting example of a hydrogenation system 100 in accordance with one or more embodiments. While specific embodiments herein are directed to a subsurface hydrogenation system, the hydrogenation system may be included in a subsurface environment, a near-subsurface environment, a surface environment connected to a formation location, or combinations thereof. For example, the formation location may include a wellbore, a downhole location of a formation, a near-wellbore location, a wellhead, surface piping, or any combination thereof.

As one of ordinary skill may appreciate, subsurface conditions in a formation (e.g., formation 108) can reach pressures above 30,000 psi and temperatures above 260° C. As such, subsurface conditions in a formation may be sufficient to supply the energy requirements (e.g., sufficient temperature and pressure) to overcome the kinetic barriers of the hydrogenation reaction described above such that a hydrogenated organic carrier may be formed from a catalyst, a reactive hydrogen compound, and an organic carrier. The formation of one or more embodiments may include a reactive hydrogen compound (e.g., hydrogen (H₂), hydrogen sulfide (H₂S). The reactive hydrogen compound may in the formation itself, in a hydrocarbon mixture within a formation (e.g., in a hydrocarbon mixture within a hydrocarbon bearing reservoir), or combinations thereof.

In some embodiments, the hydrogenation system 100 includes an organic carrier injection line 106 and a catalyst injection line 114. In some embodiments, the hydrogenation system 100 includes a hydrogen injection line (not shown). In one or more embodiments, the hydrogen injection line (not shown), the organic carrier injection line 106, the catalyst injection line 114, or any combination thereof may be the same or different. The hydrogen injection line (not shown), the organic carrier injection line 106, the catalyst injection line 114, or any combination thereof may be a capillary tubing that extends from a surface location 102 through formation 108 via a wellbore 110. In some embodiments, a reactive hydrogen compound is present in the formation such that the hydrogenation system does not require a hydrogen injection line to inject an external source of hydrogen.

The organic carrier injection line 106 may be in fluid communication with an organic carrier unit 104. Organic carrier unit 104 may be located at a surface location 102 of the formation 108, such that the organic carrier injection line 106 is configured to transport an organic carrier from the organic carrier unit 104 at the surface location 102 of the formation 108 to a downhole location 112.

In some embodiments, the organic carrier may be configured to react with a reactive hydrogen compound and form a hydrogenated organic carrier. The organic carrier may be configured to react with a reactive hydrogen compound in the presence of a catalyst to form a hydrogenated organic carrier. The organic carrier may include cyclic forms of hydrocarbons, such as hydrocarbons that include a single cyclic hydrocarbon or hydrocarbons with multiple cyclic hydrocarbons. The organic carrier may include one or more heterocyclic groups, where the heterocycle(s) may include one or more atoms selected from the group consisting of nitrogen, sulfur, boron, selenium, phosphorous, oxygen, and combinations thereof. Non-limiting examples of organic carriers that include heterocyclic groups include, but are not limited to, N-ethylcarbazole, thiophenes, phosphorines, thiaborolide, and selenophenes. The organic carrier may be an unsaturated organic material. The organic carrier may include one or more materials selected from the group consisting of biphenyl, benzytoluene, dibenzyltoluene, N-ethyl-carbazole, pyrazine, trimethylpyrazine, tetramethylpyrazine, dimethylpyrazine, triazine, aniline, N-methyl-aniline, N,N-dimethyl-aniline, diphenylamine, triphenylamine, and combinations thereof.

In some embodiments, the organic carrier includes a liquid organic carrier, a non-liquid organic carrier, or both. In some embodiments, the organic carrier is a non-liquid organic carrier dissolved in a liquid organic carrier. The term “liquid organic carrier” refers to an organic carrier that is a liquid at room temperature, such as between 20° C. to 27° C. The term “non-liquid organic carrier” refers to an organic carrier that is a solid or gaseous at room temperature (i.e., between 20° C. to 27° C.).

In some embodiments, the organic carrier is provided in the form of a solution. In such embodiments, the organic carrier solution includes a solvent and a liquid organic carrier, a non-liquid organic carrier, or combinations thereof. The solvent may promote the hydrogenation reaction, dissolve a non-liquid organic carrier, dissolve a liquid organic carrier, or any combination thereof. In some embodiments, the organic carrier includes a liquid organic carrier, a non-liquid organic carrier, or both dissolved in a solvent. The solvent of one or more embodiments includes an organic fluid, an aqueous fluid, or combinations thereof. Non-limiting examples of organic carriers that are water soluble include methanol and carboxylic acid containing compounds. Non-limiting examples of the solvent include, but are not limited to hydrocarbon solvents, alcohol solvents, acidic solvents, ether-based solvents, among others. Non-limiting examples of solvents may include one or more selected from the group consisting of toluene, paratoluenesulfonic acid, hexane, hexafluoroisopropanol, 1,4-dioxane, diesel, and combinations thereof.

In one or more embodiments, the organic carrier, the organic carrier solution, or both includes other additives provided the additives do not interfere with the hydrogenation and dehydrogenation reaction of the organic carrier, the catalyst, and reactive hydrogen compound in subsurface formation conditions. Such additives may include, for instance, one or more wetting agents, corrosion inhibitors, biocides, surfactants, dispersants, interfacial tension reducers, mutual solvents, and thinning agents. The identities and use of the aforementioned additives are not particularly limited. One of ordinary skill in the art will, with the benefit of this disclosure, will appreciate that the inclusion of a particular additive will depend upon the stage of reservoir operations, desired application, and properties of a given wellbore fluid.

Referring back to FIG. 1, the catalyst injection line 114 may be in fluid communication between a catalyst source unit 116 and a downhole location 112 of the wellbore. The catalyst source unit may be located at a surface location of the formation, such that the catalyst injection line is configured to deliver catalyst from the catalyst source unit from the surface location of the formation to a downhole location (e.g., a reaction zone) in the wellbore. The catalyst source unit may include at least one catalyst.

In some embodiments, at least one catalyst is dissolved in a carrier fluid. The carrier fluid may include an ionic liquid, a deep eutectic solvent, or combinations thereof. The catalyst may be injected such that the catalyst is deposited into a reaction zone, such that the reaction zone is a downhole location (e.g., a rock of the formation), as part of the production line, the wellbore, the casing, the tubing, or combinations thereof.

The hydrogenation system of one or more embodiments may include a hydrogenation flow reactor. In such embodiments, the catalyst may be injected into or deposited within the flow reactor. The flow reactor in fluid communication with a wellbore, a well-head, surface piping, or any combination thereof, such that the flow reactor receives a hydrocarbon mixture that includes a reactive hydrogen compound and an organic carrier. In such embodiments, the flow reactor may produce the hydrogenated organic carrier. The hydrogenation system may be configured such that the catalyst may be replaced, replenished, or both.

In some embodiments, a catalyst is not necessary to produce hydrogenated organic carriers. In such embodiments, the hydrogenation system includes one or more selected from a plasma unit, a voltage unit, or combinations thereof to promote a catalyst-free hydrogenation reaction.

A catalyst of one or more embodiments is a hydrogenation catalyst configured to promote a reaction between an organic carrier and a reactive hydrogen compound. The catalyst may be one or more catalysts selected from the group consisting of earth abundant materials (e.g., allotropes of carbon, sulfur, nitrogen and mixtures thereof), transition metal sulfides, post-transition metal sulfides, lanthanide group sulfides, actinide group sulfides, metal carbides, sulfidized carbon allotropes, nitridized carbon allotropes, and combinations thereof. Allotropes of carbon include, but are not limited to fullerenes, Buckminsterfullerenes (i.e., Buckyballs), graphene, graphite, carbon nanotubes, amorphous carbon, among others. The catalyst of one or more embodiments may include, but are not limited to, metal sulfide compounds of one or more metals selected from the group consisting of Ti, V, Cr, Mn, Fe, Co, Ni, Cu, Zn, Al, Ga, In, Sn, Zr, Nb, Mo, Tc, Ru, Rh, Pd, Ag, Cd, Hf, Ta, W, Re, Os, Ir, Au, Hg, Tl, Pb, Bi, and combinations thereof.

The catalyst of one or more embodiments may have enhanced long term stability under downhole conditions and where sulfur-related compounds may be present compared to when other catalytic materials are used. In some embodiments, the catalyst for dehydrogenation, such as a dehydrogenation catalyst to regenerate the organic carrier and the reactive hydrogen compound, and the hydrogenation catalyst are the same or different. In embodiments in which the hydrogenation catalyst and the dehydrogenation catalyst are the same, the dehydrogenation reaction may be performed with an increased temperature and a decreased pressure relative to the hydrogenation reaction.

The amount of catalyst used, for example, may depend upon the amount of the reactive hydrogen compound to be used to form the hydrogenated organic carrier, the amount of the organic carrier to be injected, desired residence time, operating temperature, operating pressure, or any combination thereof. The catalyst may be used at a molar ratio to the organic carrier in a range from 0.01:1 to 1:1. The ratio of the catalyst to the organic carrier may impact the hydrogenation reaction time.

In some embodiments, the hydrogenation system is a catalyst-free hydrogenation system. In such embodiments, the catalyst-free hydrogenation system includes one or more units configured for plasma catalysis, voltage-based catalysis, or combinations thereof to hydrogenate an organic carrier.

A reactive hydrogen compound may be present in the formation, a hydrocarbon mixture of the formation, or both such that the hydrogen is “naturally occurring.” For example, the naturally occurring reactive hydrogen compound may include “gold hydrogen” present in a formation. A naturally occurring reactive hydrogen compound may be a reactive hydrogen compound present in a well, a wellhead, a wellbore, proximate to the wellbore, piping, a subsurface structure, a subsurface formation or combinations thereof. The reactive hydrogen compound of one or more embodiments includes hydrogen (H₂). The reactive hydrogen compound may include a mixture of hydrogen sulfide and hydrogen. In some embodiments, the reactive hydrogen compound is a bisulfide compound, such as hydrogen sulfide (H₂S), a sulfur intermediate species (H₂S^{—} HS^{—}, Sₙ^{2—}), or a mixture thereof.

An external energy may be used to promote hydrogenation. External energies include, but are not limited to, temperature, light (e.g., ultraviolet (UV), visible light, or both), microwave irradiation, ultrasound technology, electricity, or any combination thereof could drive the dehydrogenation. In some embodiments, energy is harvested from an energy source (e.g., as thermal energy). The energy may be harvested from an energy source, including, but not limited to, a hydrocarbon-bearing reservoir, a geothermal reservoir, a nuclear power plant, renewable energy sources (e.g., wind, solar, water sources), a hydrocarbon combustion reaction, thermal energy produced from the hydrogenation reaction itself, or any combination thereof. The harvested energy may be used to enhance the rate of a hydrogenation reaction, a dehydrogenation reaction, or both.

In some embodiments, a reactive hydrogen compound is not present in a formation, a hydrocarbon mixture of the formation, or both in a sufficient amount to affect a reaction with an organic carrier in the presence of a catalyst. In such embodiments, an external source of hydrogen is provided at a surface location of the formation. The external source of hydrogen may be obtained from one or more hydrogen-producing processes, one or more alternative other formations, or both. In such embodiments, the system includes a hydrogen injection line. The hydrogen injection line may be in fluid communication with a hydrogen unit. The hydrogen unit may be located at a surface location of the formation, such that the hydrogen injection line is configured to deliver hydrogen from the reactive hydrogen unit from the surface location of the formation to a downhole location.

In one or more embodiments, an organic carrier is in molar excess to a reactive hydrogen compound. The amount of organic carrier used, for example, may depend upon the amount of a reactive hydrogen compound present in the formation, the amount of a reactive hydrogen compound injected into the wellbore of the formation, or both. The organic carrier may be used at a molar ratio to the reactive hydrogen compound in a range from 10:1 to 0.01:1. The ratio of the organic carrier to the reactive hydrogen compound may impact the hydrogenation reaction time.

Embodiments herein may be useful over a wide range of conditions, including subsurface conditions in a wellbore, conditions in a near-wellbore location, wellhead, or surface piping. For example, the conditions for promoting hydrogenation may include temperatures of up to 75° C., such as up to about 70° C., up to about 65° C., up to about 60° C., up to about 50° C., up to about 40° C., up to about 30° C., up to about 25° C., up to about 10° C., or up to about 0° C. Pressures may be from at least about 25 psi or above, at least about 30 psi or above, at least about 40 psi or above, at least about 50 psi or above, at least about 75 psi or above, at least about 100 psi or above, at least about 200 psi or above, at least about 300 psi or above, at least about 500 psi or above, at least about 600 psi or above, at least about 750 psi or above, or at least about 1,000 or above. At these subsurface conditions, the system may start to form a hydrogenated organic carrier instantaneously within seconds, minutes, or hours (i.e. a hydrogenation reaction time).

In some embodiments, the time to form a hydrogenated organic carrier (or “hydrogenation reaction time” depends on several parameters, such as location for catalyst placement, flow, diameter, placement length (e.g. from subsurface to surface piping of 100 kilometers or above).

### Method for Hydrogenating an Organic Carrier

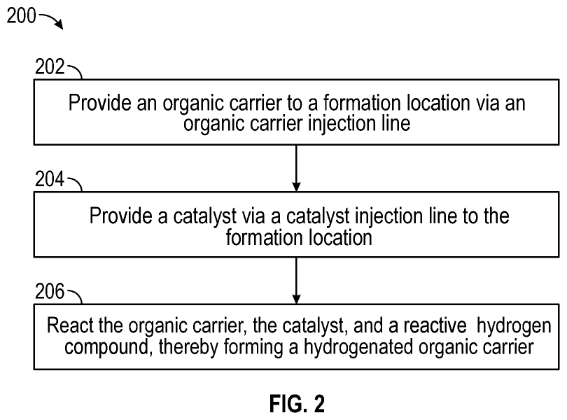

In another aspect, embodiments disclosed herein relate to a method for hydrogenating an organic carrier. The term “hydrogenating an organic carrier” refers to reacting an organic carrier and a reactive hydrogen compound to form a hydrogenated organic carrier. In such embodiments, the hydrogenation reaction to form a hydrogenated organic carrier is reversible such that under reversed conditions, a dehydrogenated organic carrier and the reactive hydrogen compound are produced. FIG. 2 is a flow diagram of a method 200 for hydrogenating an organic carrier in accordance with one or more embodiments. A method 200 of hydrogenating an organic carrier according to one or more embodiments includes providing a hydrogenation system. The hydrogenation reaction may be as described previously. While specific embodiments herein are directed to hydrogenation of organic carriers in subsurface locations, the hydrogenation system of one or more embodiments may be included in a wellbore, near-wellbore location, wellhead, surface piping, or any combination thereof.

As shown in block 202, the method may include injecting an organic carrier into a formation via an organic carrier injection line disposed in the wellbore of the formation. The organic carrier may be as described previously. In block 204, a catalyst may be injected in the wellbore of the formation (or the formation itself) via a catalyst injection line disposed in the wellbore of the formation. In some embodiments, block 204 is performed prior to block 202. The injection of the catalyst may be performed simultaneously with the injection of the organic carrier.

In some embodiments, the organic carrier and the catalyst mix with a naturally occurring reactive hydrogen compound in the formation. In some embodiments, the organic carrier and the catalyst are pre-mixed prior to injection in the wellbore of the formation. In such embodiments, the pre-mixed organic carrier and catalyst are injected into the formation together.

In formations in which a reactive hydrogen compound is not present in the formation, a reactive hydrogen compound may be injected into the formation via the organic carrier injection line, the catalyst injection line, a hydrogen injection line disposed in the wellbore of the formation, or combinations thereof. As mentioned above, the organic carrier injection line, the catalyst injection line, and the hydrogen injection line may be the same or different. The method may include injecting the hydrogen from a surface location of the formation to a subsurface location in the wellbore of the formation.

As mentioned above and shown in block 206, the combination of a catalyst, hydrogen, and an organic carrier in a subsurface location, such as in a downhole location of a wellbore, forms a hydrogenated organic carrier via a hydrogenation reaction. In one or more embodiments, the catalyst acts as an activator to promotes the hydrogenation of the organic carrier. In one or more embodiments, the hydrogenation of an organic carrier is facilitated by increasing the pressure, temperature, or both. Increasing the pressure, temperature, or both may be facilitated by providing the catalyst, the organic carrier, and a hydrogen reactive compound to a formation location, such as a wellbore, a downhole location in a formation, surface piping, a wellhead, a near-wellbore location, or combinations thereof. In particular embodiments, the reaction of the organic carrier, the catalyst, and a reactive hydrogen compound may be facilitated via injection to a subsurface location in a wellbore of the formation.

The method of one or more embodiments includes allowing the catalyst, the hydrogen, and the organic carrier to react in the wellbore for a period of time. The time for hydrogenating an organic carrier may be the hydrogenation reaction time as described previously.

The method may include monitoring the hydrogenation reaction. Monitoring the hydrogenation reaction may include producing a sample of a reaction mixture from the wellbore. In such embodiments, the produced sample is analyzed using one or more methods selected from colorimetric analysis, density analysis, high-performance liquid chromatograph (HPLC) analysis, gas chromatography (GC), spectroscopic methods, among others. As such, the hydrogenation reaction may be determined complete when a portion of hydrogen is converted to the hydrogenated organic carrier, when a majority of hydrogen is converted to the hydrogenated organic carrier, or when all of the hydrogen is converted to the hydrogenated organic carrier. When the hydrogenation reaction is determined to be complete, the hydrogenated organic carrier may be produced at a surface location. The hydrogenated organic carrier may be produced at a surface location using one or more production units as known to those skilled in the art. The hydrogenated organic carrier may have low solubility in water, have a low boiling point, or both.

In some embodiments, the hydrogenation of an organic carrier is facilitated by providing energy from one or more energy sources selected from the group consisting of geothermal energy, renewable energy, nuclear energy, hydrocarbon combustion, exothermal energy generated and harvested from the hydrogenation reaction. Energy provided from one or more energy sources may increase a rate of hydrogenation, dehydrogenation, or both. For subsurface or surface hydrogenation conditions the energy may be provided with the use of a heat exchanger from energy produced, converted, or stored in the surface of the formation or from the hydrogenation reaction itself. For hydrogenation reactions performed at surface conditions, energy may be harvested directly from solar energy, wind energy, or both.

In some embodiments, the method for producing a reactive hydrogen compound from a formation includes dehydrogenating a hydrogenated organic carrier. The hydrogenated organic carrier may be recovered at a surface location of the formation such that the hydrogenated organic carrier is produced from the downhole location of the wellbore of the formation. The recovered hydrogenated organic carriers may undergo a dehydrogenation reaction in one or more dehydrogenation units at a surface location, at an off-site location (e.g., a laboratory or a refinery), or both. In such embodiments, the dehydrogenation is an endothermic process to regenerate the organic carrier and produce the reactive hydrogen compound. In embodiments in which a hydrocarbon stream is mainly composed of reactive hydrogen compound and organic carrier dissolved in the stream, a separation process is beneficial, such as in a gas-oil separation plant.

The term “dehydrogenating a hydrogenated organic carrier” refers to a reverse hydrogenation reaction to regenerate an organic carrier and produce a reactive hydrogen compound. For example, when the conditions of a hydrogenation reaction are reversed, such as under “dehydrogenation conditions,” the hydrogenated organic carrier undergoes a dehydrogenation reaction that regenerates the organic carrier in its dehydrogenated form and produces a reactive hydrogen compound. Dehydrogenating a hydrogenated organic carrier may be facilitated by providing energy from one or more energy sources selected from the group consisting of geothermal energy, renewable energy, nuclear energy, or hydrocarbon combustion. In some embodiments, the dehydrogenation unit operates at higher temperatures and lower pressures, relative to the units to promote hydrogenation. The catalyst for the dehydrogenation reaction may be the same catalyst used for the hydrogenation reaction.

The dehydrogenation reaction may occur under higher temperatures, lower pressures, or both, relative to the hydrogenation reaction to regenerate the reactive hydrogen compound and the organic carrier. In some embodiments, the reactive hydrogen compound bubbles out of the regenerated organic carrier after a dehydrogenation reaction. In some embodiments, a portion or all of the regenerated organic carrier may be reinjected into the wellbore of the formation, thereby recycling the organic carrier. As such, one or more aspects of the method of one or more embodiments may be repeated with the recycled organic carrier.

In some embodiments, the regenerated hydrogen may be further refined utilizing specialized hydrogen-based processes that are known to those skilled in the art. These techniques may include, but are not limited to, dehydration, pressure swing adsorption, temperature swing adsorption, and membrane separation. Separation of hydrogen from other materials may take the form of a combination of these or other techniques in order to obtain hydrogen of sufficient purity for use in the intended applications.

In one or more embodiments, the reactive hydrogen compound recovered from the hydrogenated organic carrier may have purity in a range of greater than 50% reactive hydrocarbon gas, such as greater than 60%, such as greater than 70%, such as greater than 80%, such as greater than 90%, such as greater than 95%, such as greater than 98%, such as greater than 99%, such as greater than 99.9%. In one or more embodiments, impurities may include water (H₂O), carbon dioxide (CO₂), nitrogen (N₂), light hydrocarbon molecules such as methane (CH₄), ethane (C₂H₆), among others. In some embodiments, a hydrocarbon stream including the regenerated reactive hydrogen compound and the dehydrogenated organic carrier is separated in a gas-oil separation plant (GOSP) process.

Embodiments of the present disclosure may provide at least one of the following advantages. A reactive hydrogen compound may be stored via reaction with an organic carrier and a catalyst in a subsurface location to form a hydrogenated organic carrier. In some embodiments, a reactive hydrogen compound is stored in the form of a hydrogenated organic carrier for future use in one or more applications, such as an energy source or as an energy storage medium. The system and method of one or more embodiments may provide safer and more efficient handling of a reactive hydrogen compound as compared to traditional hydrogen production and storage systems and methods. The lower enthalpy of formation of hydrogenated organic carriers may have a decreased reactivity to subsurface formations and systems in comparison to an unbound reactive hydrogen compound. Additionally, some hydrogenated organic carriers have low solubility in water and low boiling points, allowing for simpler separation techniques. One or more embodiments of the present disclosure prevent deleterious degradation mechanisms of hydrogenated organic carriers. In some embodiments, one or more organic carriers have antibacterial properties that can disrupt biological degradation mechanisms of hydrogen, hydrogenated organic carriers, or both.

Throughout the application, ordinal numbers (for example, first, second, third) may be used as an adjective for an element (that is, any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a horizontal beam” includes reference to one or more of such beams.

Terms such as “approximately” or “substantially” mean that the recited characteristic, parameter, or value need not be achieved exactly, but that deviations or variations, including, for example, tolerances, measurement error, measurement accuracy limitations, and other factors known to those of skill in the art, may occur in amounts that do not preclude the effect the characteristic was intended to provide.

It is to be understood that one or more of the steps shown in the flowcharts may be omitted, repeated, or performed in a different order than shown. Accordingly, the scope disclosed should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1. A method for hydrogenation, the method comprising:
providing an organic carrier to a formation location via an organic carrier injection line;
providing a catalyst via a catalyst injection line to the formation location; and
reacting the organic carrier, the catalyst, and a reactive hydrogen compound at the formation location, thereby forming a hydrogenated organic carrier,
wherein the formation location is a subsurface environment, near-subsurface environment, a surface connected environment, or any combination thereof.

2. The method of claim 1, wherein providing the organic carrier and the catalyst is performed simultaneously.

3. The method of claim 1, wherein providing the catalyst is performed prior to providing the organic carrier.

4. The method of claim 1, further comprising dehydrogenating the hydrogenated organic carrier by providing energy harvested from one or more selected from a geothermal energy reservoir, a renewable energy reservoir, a nuclear energy reservoir, a hydrocarbon combustion reaction, or combinations thereof.

5. The method of claim 1, further comprising increasing a rate of a hydrogenation reaction by providing energy harvested from one or more energy sources selected from a geothermal energy reservoir, a renewable energy reservoir, a nuclear energy reservoir, a hydrocarbon combustion reaction, exothermal energy generated from the hydrogenation reaction, or combinations thereof.

6. The method of claim 1, wherein the reactive hydrogen compound is naturally occurring hydrogen present in a formation, a hydrocarbon mixture of the formation, or both.

7. The method of claim 1, wherein the reactive hydrogen compound comprises hydrogen, hydrogen sulfide, or combinations thereof.

8. The method of claim 1, further comprising injecting the reactive hydrogen compound to the formation location via the organic carrier injection line, the catalyst injection line, a hydrogen injection line, or combinations thereof.

9. The method of claim 1, wherein the formation location is a location in a formation, in a wellbore, a near-wellbore location, a wellhead, surface piping of the formation, or any combination thereof.

10. The method of claim 1, further comprising mixing the organic carrier and the catalyst prior to injection to the formation location.

11. The method of claim 1, further comprising:
recovering the hydrogenated organic carrier from the formation location;
dehydrogenating the hydrogenated organic carrier to regenerate the organic carrier and hydrogen; and
reinjecting the organic carrier into the formation location, thereby recycling the organic carrier.

12. The method of claim 1, wherein the organic carrier comprises a solvent, a liquid organic carrier, a non-liquid organic carrier, or combinations thereof, wherein the liquid organic carrier, the non-liquid organic carrier, or both comprise one or more cyclic hydrocarbon groups, and wherein the one or more cyclic hydrocarbon groups comprises one or more atoms selected from the group consisting of nitrogen, sulfur, boron, selenium, phosphorous, oxygen.

13. The method of claim 12, wherein the non-liquid organic carrier is dissolved in a solvent, a liquid organic carrier, or both.

14. A hydrogenation system comprising:
an organic carrier injection line configured for injecting an organic carrier comprising one or more selected from a liquid organic carrier, a non-liquid organic carrier, or combinations thereof to a formation location; and
a catalyst injection line configured for injecting a catalyst to the formation location,
wherein the hydrogenation system is configured to react the organic carrier, the catalyst, and a reactive hydrogen compound at a subsurface location, hydrogenate the organic carrier, and form a hydrogenated organic carrier, and
wherein the formation location is a subsurface environment, near-subsurface environment, a surface connected environment, or any combination thereof.

15. The hydrogenation system of claim 14, wherein the reactive hydrogen compound is a naturally occurring hydrogen present in a formation, a hydrocarbon mixture of the formation, or both.

16. The hydrogenation system of claim 14, wherein the organic carrier is in the form of an organic carrier solution, wherein the organic carrier solution comprises a solvent and one or more selected from the group consisting of the liquid organic carrier, the non-liquid organic carrier, and combinations thereof.

17. The hydrogenation system of claim 16, wherein the solvent comprises one or more solvents selected from the group consisting of toluene, paratoluenesulfonic acid, hexane, hexafluoroisopropanol, 1,4-dioxane, diesel, and combinations thereof.

18. The hydrogenation system of claim 14, wherein the organic carrier comprises one or more selected from the group consisting of thiophene, phosphorine, thiaborolide, selenophene, biphenyl, benzyltoluene, dibenzyltoluene, N-ethyl-carbazole, pyrazine, trimethylpryazine, tetramethylpryazine, dimethylpyrazine, triazine, aniline, N-methyl-aniline, N,N-dimethyl-aniline, diphenylamine, triphenylamine, and combinations thereof.

19. The hydrogenation system of claim 14, wherein the catalyst is one or more catalysts selected from the group consisting of allotropes of carbon, sulfur, transition metal sulfides, post-transition metal sulfides, lanthanide group sulfides, actinide group sulfides, and combinations thereof.

20. The hydrogenation system of claim 14, wherein the reactive hydrogen compound comprises hydrogen, hydrogen sulfide (H₂S), or combinations thereof.
